(19) United States
(12) Patent Application Publication
(10) Pub. No.: US 2024/0054981 A1
(43) Pub. Date: Feb. 15, 2024

(54) Musical Bodysuit Assembly

(71) Applicant: Jason Johnson, Bradenton, FL (US)

(72) Inventor: Jason Johnson, Bradenton, FL (US)

(21) Appl. No.: 17/884,624

(22) Filed: Aug. 10, 2022

(51) Int. Cl. G10H 1/00; G10H 1/34; H04R 1/02; H04R 1/40; H04R 3/12; A41D 1/00

(52) U.S. Cl. CPC G10H 1/0008; G10H 1/344; H04R 1/028; G10H 1/0041; H04R 1/403; H04R 3/12; A41D 1/002; G10H 2220/201; G10H 2220/265; G10H 2240/145; G10H 2220/321; H04R 2201/023

(57) ABSTRACT

A musical bodysuit assembly includes a bodysuit that is wearable on a user. A plurality of sound pads is each strategically located on the bodysuit thereby facilitating each of the sound pads to be touched by the user when the user is performing dance moves. Each of the sound pads has a speaker for emitting audible sounds and each of the sound pads has touch sensing capabilities. The speaker in a respective sound pad is turned on to emit an audible sound when the respective sound pad is touched by the user to produce music that corresponds to dance moves performed by the user. A communication unit is in communication with the speaker in each of the sound pads and the communication unit has wireless communication capabilities thereby facilitating the communication unit to download digital audio from a remote data source.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to bodysuit devices and more particularly pertains to a new bodysuit device for facilitating a user to make music that corresponds to dance moves being performed by the user. The device includes a bodysuit that is worn by the user and a plurality of sound pads each attached to the bodysuit. The device includes a communication unit that is in communication between the sound pads and a personal electronic device for downloading audio data into the communication unit. Each of the sound pads is touch sensitive and each of the sound pads emits a unique audible sound with respect to each other when the sound pads are touched.

### (2) Description of Related Art Including Information Disclosed Under 37 CFR 1.97 and 1.98

The prior art relates to bodysuit devices including electronic apparel that generates light or sound in reaction to various sensors on the garment. The prior art discloses a chair with motions sensors that are in communication with an audio unit to generate audible sounds based on movement of a user in the chair. The prior art discloses musical gloves that is in communication with a MIDI controller for generating musical melodies. The prior art discloses an article of clothing which has vibration motors for generating tactile feedback that is in communication with an intelligent control. The prior art discloses a segmented bodysuit which has ultrasonic transducers for facilitating ultrasonic therapy. The prior art discloses a jacket that has lights and speakers which are in wireless communication with a personal electronic device.

### (h) BRIEF SUMMARY OF THE INVENTION

An embodiment of the disclosure meets the needs presented above by generally comprising a bodysuit is wearable on a user. A plurality of sound pads is each strategically located on the bodysuit thereby facilitating each of the sound pads to be touched by the user when the user is performing dance moves. Each of the sound pads has a speaker for emitting audible sounds and each of the sound pads has touch sensing capabilities. The speaker in a respective sound pad is turned on to emit an audible sound when the respective sound pad is touched by the user to produce music that corresponds to dance moves performed by the user. A communication unit is in communication with the speaker in each of the sound pads and the communication unit has wireless communication capabilities thereby facilitating the communication unit to download digital audio from a remote data source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a musical bodysuit assembly according to an embodiment of the disclosure.

FIG. 2 is a right side in-use view of an embodiment of the disclosure.

FIG. 3 is a back in-use view of an embodiment of the disclosure.

FIG. 4 is a perspective view of personal electronic device of an embodiment of the disclosure.

FIG. 5 is a schematic view of an embodiment of the disclosure.

### (j) DETAILED DESCRIPTION OF THE INVENTION

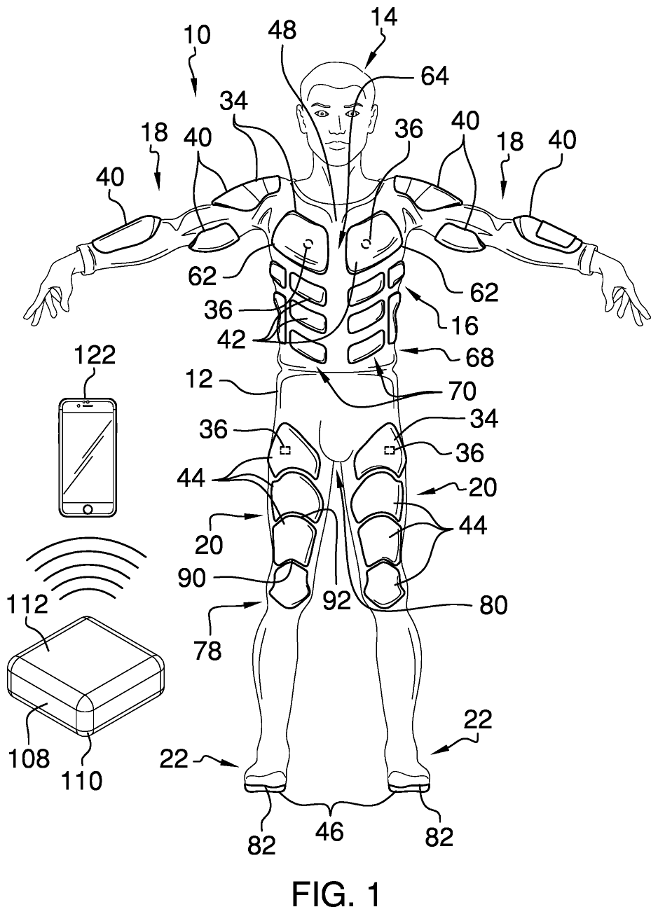

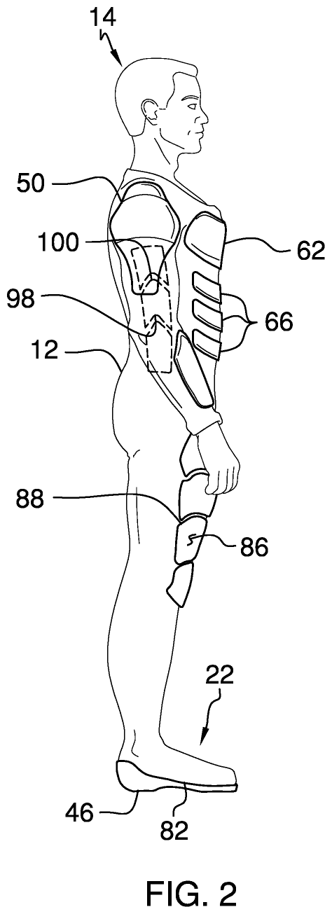

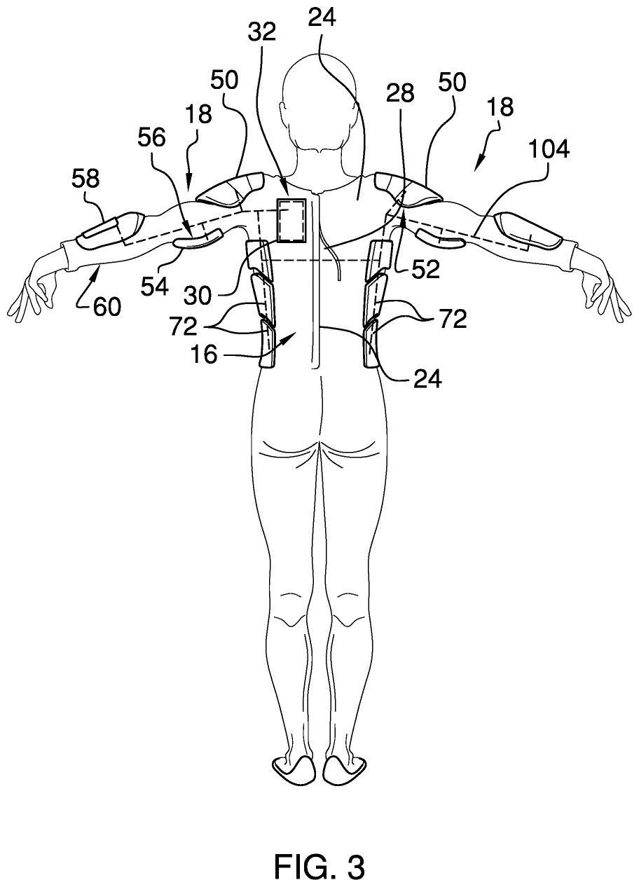

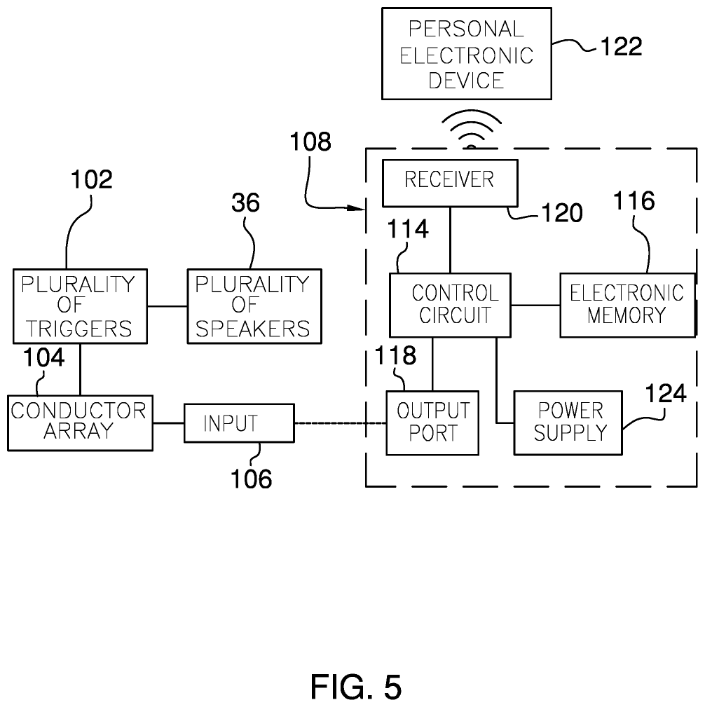

With reference now to the drawings, and in particular to FIGS. 1 through 5 thereof, a new bodysuit device embodying the principles and concepts of an embodiment of the disclosure and generally designated by the reference numeral 10 will be described.

As best illustrated in FIGS. 1 through 5, the musical bodysuit assembly 10 generally comprises a bodysuit 12 that is wearable on a user 14. The bodysuit 12 has a torso 16, a pair of arms 18, a pair of legs 20 and a pair of feet 22. The torso 16 has a back side 24 and the back side 24 has a cut 26 extending downwardly along the back side 24 to facilitate the bodysuit 12 to be donned by the user 14. The bodysuit 12 is comprised of an elastomeric material thereby facilitating the bodysuit 12 to be formfitting on the user 14. The bodysuit 12 might include a closure 28, such as a zipper for example, that runs the length of the cut 26 to facilitate the cut 26 to be opened or closed.

A pocket 30 is coupled to the bodysuit 12, the pocket 30 is positioned on the back side 24 of the torso 16 and the pocket 30 has an opening 32 extending into an interior of the pocket 30. A plurality of sound pads 34 is provided and each of the sound pads 34 is coupled to the bodysuit 12. Each of the sound pads 34 is strategically located on the bodysuit 12 thereby facilitating each of the sound pads 34 to be touched by the user 14 when the user 14 is performing dance moves. Additionally, each of the sound pads 34 has a speaker 36 for emitting audible sounds and each of the sound pads 34 has touch sensing capabilities. The speaker 36 in a respective sound pad 34 is turned on to emit an audible sound when the respective sound pad 34 is touched by the user 14. In this way the plurality of sound pads 34 facilitates the user 14 to produce music that corresponds to the dance moves being performed by the user 14.

The plurality of sound pads 34 includes a set of arm pads 40, a set of torso pads 42, a set of leg pads 44 and a set of foot pads 46. Each of the arm pads 40 is positioned on a respective one of the arms 18 of the bodysuit 12 and each of the torso pads 42 is positioned on a front side 48 of the torso 16 of the bodysuit 12. Each of the leg pads 44 is positioned on a respective one of the legs 20 of the bodysuit 12. Continuing, each of the sets of arm pads 40 includes a shoulder pad 50 aligned with a shoulder 52 of a respective arm 18, an elbow pad 54 aligned with an elbow 56 of a respective arm 18 and a forearm pad 58 aligned with a forearm 60 of a respective arm 18. The set of torso pads 42 includes a pair of chest pads 62 that is each positioned on a chest 64 of the torso 16. Additionally, the set of torso pads 42 includes a plurality of stomach pads 66 that are spaced apart from each other and are distributed between the chest pads 62 and a waist 68 of the bodysuit 12, and the stomach pads 66 are arranged into a pair of columns 70.

The set of torso pads 42 includes a set of side pads 72 that is each positioned on a respective first lateral side 74 and second lateral side 76 of the torso 16. The side pads 72 are spaced apart from each other and are distributed between the waist of the bodysuit 12 and a respective one of the arms 18. Each of the sets of leg pads 44 are spaced apart from each other and are distributed between a knee 78 of a respective leg 20 and a crotch 80 of the bodysuit 12. Additionally, each of the foot pads 46 is positioned on a sole 82 of a respective foot 22 of the bodysuit 12.

Each of the sound pads 34 is comprised of a deformable material such as rubber or the like thereby facilitating each of the sound pads 34 to absorb impact energy resulting from the user 14 touching or striking the sound pads 34. Additionally, each of the sound pads 34 has an exposed surface 86 with respect to the bodysuit 12 and a perimeter edge 88. The perimeter edge 88 of each of the shoulder pads 50 curves outwardly proximate a center of said shoulder pads 50 such that said shoulder pads 50 has a bulbous shape. The perimeter edge 88 of each of the leg pads 44 has a bottom side 90 that is concavely arcuate and a top side 92 that is convexly arcuate thereby facilitating the leg pads 44 to conform to each other. Each of the stomach pads 66 is elongated between a first lateral side 94 and a second lateral side 96 of the perimeter edge 88 of the stomach pads 66. The perimeter edge 88 of each of the side pads 72 has a lower side 98 that is concavely arcuate and an upper side 100 that is convexly arcuate thereby facilitating the side pads 72 to conform to each other.

A plurality of triggers 102 is provided and each of the triggers 102 is integrated into a respective one of the sound pads 34 thereby facilitating each of the triggers 102 to be actuated when the user 14 touches or strikes the respective sound pad 34. Each of the triggers 102 is in communication with the speaker 36 in a respective one of the sound pads 34. Additionally, each of the triggers 102 may be an electronic pressure sensor or other type of device that can sense when the respective sound pad 34 is touched or hit. A conductor array 104 is integrated into the bodysuit 12, the conductor array 104 is in electrical communication with each of the triggers 102 and the conductor array 104 has an input 106.

A communication unit 108 is insertable into the pocket 30 and the communication unit 108 is in communication with the speaker 36 in each of the sound pads 34. The communication unit 108 has data storage capabilities thereby facilitating the communication unit 108 to store digital audio. Furthermore, the communication unit 108 has wireless communication capabilities thereby facilitating the communication unit 108 to download digital audio from a remote data source. The communication unit 108 comprises a housing 110 that has an outer wall 112 and the housing 110 is insertable into the pocket 30.

The communication unit 108 includes a control circuit 114 that is integrated into the housing 110 and the control circuit 114 receives an audio input. The control circuit 114 includes an electronic memory 116 and the electronic memory 116 stores the database comprising the digital audio. Additionally, the electronic memory 116 stores a database which comprises a unique identity that is assigned to each of the triggers 102. In this way the control circuit 114 is able to identify which of the triggers 102 has been actuated.

The control circuit 114 communicates an audio signal to the speaker 36 associated with a respective one of the triggers 102 when the respective trigger 102 is actuated. In this way the speaker 36 can emit the audible sound when the user 14 touches or strikes the respective sound pad 34. The audio signal sent to the speaker 36 associated with each of the triggers 102 comprising a unique pitch and sound with respect to each other. In this way the plurality of sound pads 34 facilitate the user 14 to produce music by touching or striking the sound pads 34 in a variety of patterns and combinations.

An output port 118 is integrated into the outer wall 112 of the housing 110 and the output port 118 is electrically coupled to the control circuit 114. The output port 118 is placed in electrical communication with the input 106 of the conductor array 104 when the housing 110 is inserted into the pocket 30. In this way the control circuit 114 is in electrical communication with each of the triggers 102. The output port 118 may comprise a magnetic port, an electrical port such as universal serial bus port or any other means of establishing an electrical connection with the housing 110. The input 106 of the conductor array 104 may comprise a magnet the magnetically engages the magnetic port, an electrical plug that engages the electrical port or any other type of electronic coupling that is matable to the output port 118.

The communication unit 108 includes a receiver 120 that is integrated into the housing 110 and the receiver 120 is electrically coupled to the control circuit 114. The receiver 120 is in wireless communication with a personal electronic device 122 thereby facilitating the receiver 120 to download data from the personal electronic device 122 into the electronic memory 116. The receiver 120 may comprise a radio frequency receiver or the like and the receiver 120 may employ Bluetooth communication protocols. The personal electronic device 122 may comprise a smart phone or other similar type of device with wireless communication capabilities. The communication unit 108 includes a power supply 124 that is integrated into the housing 110. The power supply 124 is electrically coupled to the control circuit 114 and the power supply 124 comprises at least one battery 126.

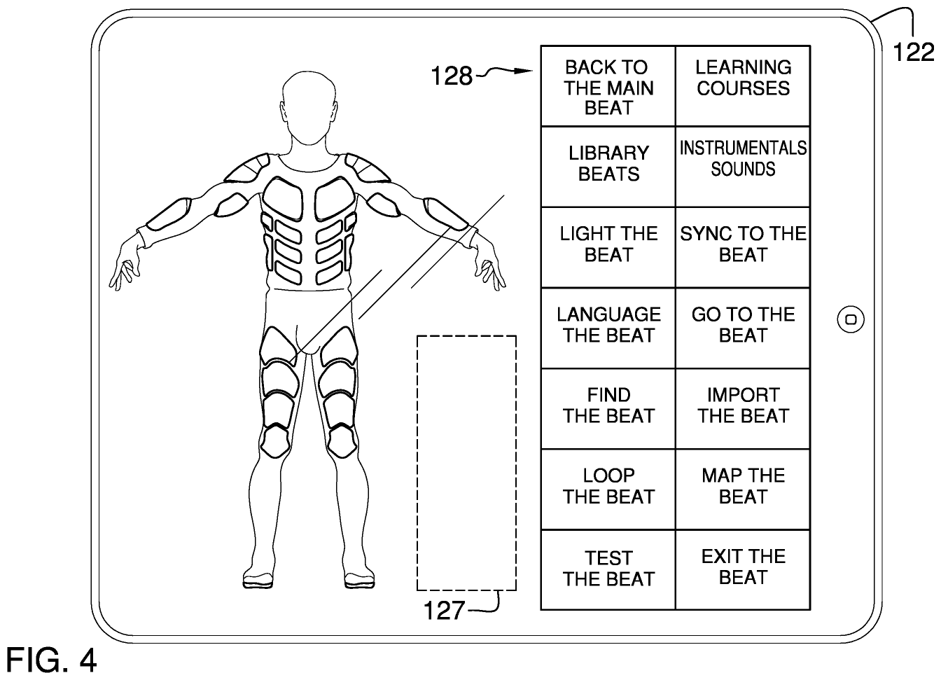

As is most clearly shown in FIG. 4, the personal electronic device 122 stores an application 127 for controlling the sound pads 34 on the bodysuit 12. The application 127 includes a variety of different sounds that can be downloaded into the electronic memory 116, which might include tonal sounds, percussive sounds and any other sounds that can be employed in conjunction with each other to compose music or other collection of sounds that are pleasing to the ear. Furthermore, the application 127 includes a variety of educational programs, including but not being limited to, arithmetic, spelling and language to facilitate the user 14 to solve a variety of problems by striking or touching sound pads 34 in a pre-determined sequence to successfully answer questions posed by the educational programs. A menu 128 might be displayed on the personal electronic device 122 that might include, but not be limited to, the categories of learning courses, instrumental sounds and a variety of dance beat options. In this way the user 14 can employ the sound pads 34 in a variety of interactive scenarios.

In use, the user 14 dons the bodysuit 12 and the user 14 synchronizes the communication unit 108 with the personal electronic device 122. The user 14 downloads chosen sounds into the electronic memory 116 and the user 14 employs the application 127 stored in the personal electronic device 122 to actuate the sound pads 34 for either composing music with the variety of sounds or answering questions from the educational programs. The user 14 strikes each of the sound pads 34 is any desired sequence, either according to dance moves or random moves, and each of the sound pads 34 emits the sound that has been assigned to the sound pads 34. In this way the user 14 can compose music while dancing, for example. The user 14 can attempt to strike the sound pads 34 according to a pre-determined pattern for answering questions from the educational programs, for example. In this way the user 14 can employ the bodysuit 12 for educational purposes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A musical bodysuit assembly for facilitating a user to make music using bodily motions, said assembly comprising:
a bodysuit being wearable on a user, said bodysuit having a torso, a pair of arms, a pair of legs and a pair of feet, said torso having a back side, said back side having a cut extending downwardly along said back side to facilitate said bodysuit to be donned by the user, said bodysuit being comprised of an elastomeric material thereby facilitating said bodysuit to be formfitting on the user;
a pocket being coupled to said bodysuit;
a plurality of sound pads, each of said sound pads being coupled to said bodysuit, each of said sound pads being strategically located on said bodysuit thereby facilitating each of said sound pads to be touched by the user when the user is performing dance moves, each of said sound pads having a speaker for emitting audible sounds, each of said sound pads having touch sensing capabilities, said speaker in a respective sound pad being turned on to emit an audible sound when said respective sound pad is touched by the user wherein said plurality of sound pads is configured to facilitate the user to produce music that corresponds to the dance moves being performed by the user; and
a communication unit being insertable into said pocket, said communication unit being in communication with said speaker in each of said sound pads, said communication unit having data storage capabilities thereby facilitating said communication unit to store digital audio, said communication unit having wireless communication capabilities thereby facilitating said communication unit to download digital audio from a remote data source.

2. The assembly according to claim 1, wherein:
said plurality of sound pads includes a set of arm pads, a set of torso pads, a set of leg pads and a set of foot pads;
each of said arm pads is positioned on a respective one of said arms of said bodysuit;
each of said torso pads is positioned on a front side of said torso of said bodysuit;
each of said leg pads is positioned on a respective one of said legs of said bodysuit.

3. The assembly according to claim 2, wherein each of said sets of arm pads includes a shoulder pad being aligned with a shoulder of a respective arm, an elbow pad being aligned with an elbow of a respective arm and a forearm pad being aligned with a forearm of a respective arm.

4. The assembly according to claim 2, wherein:
said set of torso pads includes a pair of chest pads each being positioned on a chest of said torso; and
said set of torso pads includes a plurality of stomach pads being spaced apart from each other and being distributed between said chest pads and a waist of said bodysuit, said stomach pads being arranged into a pair of columns.

5. The assembly according to claim 2, wherein said set of torso pads includes a set of side pads each being positioned on a respective first lateral side and second lateral side of said torso, said side pads being spaced apart from each other and being distributed between said waist of said bodysuit and a respective one of said arms.

6. The assembly according to claim 2, wherein each of said sets of leg pads is spaced apart from each other and being distributed between a knee of a respective leg and a crotch of said bodysuit.

7. The assembly according to claim 2, wherein each of said foot pads is positioned on a sole of a respective foot of said bodysuit.

8. The assembly according to claim 1, further comprising a plurality of triggers, each of said triggers being integrated into a respective one of said sound pads thereby facilitating each of said triggers to be actuated when the user touches or strikes said respective sound pad, each of said triggers being in communication with said speaker in said a respective one of said sound pads.

9. The assembly according to claim 8, further comprising a conductor array, said conductor array being integrated into said bodysuit, said conductor array being in electrical communication with each of said triggers, said conductor array having an input.

10. The assembly according to claim 8, wherein said communication unit comprises:
a housing having an outer wall, said housing being insertable into said pocket;
a control circuit being integrated into said housing, said control circuit receiving an audio input when any of said triggers is actuated, said control circuit including an electronic memory, said electronic memory storing said database comprising the digital audio, said electronic memory storing a database comprising a unique identity being assigned to each of said triggers, said control circuit communicating an audio signal to said speaker associated with a respective one of said triggers when said respective trigger is actuated thereby facilitating said speaker to emit the audible sound when the user touches or strikes said respective sound pad, said audio signal sent to said speaker associated with each of said triggers comprising an unique pitch and sound with respect to each other wherein said plurality of sound pads is configured to facilitate the user to produce music; and
an output port being integrated into said outer wall of said housing, said output port being electrically coupled to said control circuit, said output port being placed in electrical communication with said input of said conductor array when said housing is inserted into said pocket thereby facilitating said control circuit to electrically communication with each of said triggers.

11. The assembly according to claim 10, wherein said communication unit includes:
a receiver being integrated into said housing, said receiver being electrically coupled to said control circuit, said receiver being in wireless communication with a personal electronic device thereby facilitating said receiver to download data from said personal electronic device into said electronic memory; and
a power supply being integrated into said housing, said power supply being electrically coupled to said control circuit, said power supply comprising at least one battery.

12. A musical bodysuit assembly for facilitating a user to make music using bodily motions, said assembly comprising:
a bodysuit being wearable on a user, said bodysuit having a torso, a pair of arms, a pair of legs and a pair of feet, said torso having a back side, said back side having a cut extending downwardly along said back side to facilitate said bodysuit to be donned by the user, said bodysuit being comprised of an elastomeric material thereby facilitating said bodysuit to be formfitting on the user;
a pocket being coupled to said bodysuit, said pocket being positioned on said back side of said torso, said pocket having an opening extending into an interior of said pocket;
a plurality of sound pads, each of said sound pads being coupled to said bodysuit, each of said sound pads being strategically located on said bodysuit thereby facilitating each of said sound pads to be touched by the user when the user is performing dance moves, each of said sound pads having a speaker for emitting audible sounds, each of said sound pads having touch sensing capabilities, said speaker in a respective sound pad being turned on to emit an audible sound when said respective sound pad is touched by the user wherein said plurality of sound pads is configured to facilitate the user to produce music that corresponds to the dance moves being performed by the user, said plurality of sound pads including a set of arm pads, a set of torso pads, a set of leg pads and a set of foot pads, each of said arm pads being positioned on a respective one of said arms of said bodysuit, each of said torso pads being positioned on a front side of said torso of said bodysuit, each of said leg pads being positioned on a respective one of said legs of said bodysuit, each of said sets of arm pads including a shoulder pad being aligned with a shoulder of a respective arm, an elbow pad being aligned with an elbow of a respective arm and a forearm pad being aligned with a forearm of a respective arm, said set of torso pads including a pair of chest pads each being positioned on a chest of said torso, said set of torso pads including a plurality of stomach pads being spaced apart from each other and being distributed between said chest pads and a waist of said bodysuit, said stomach pads being arranged into a pair of columns, said set of torso pads including a set of side pads each being positioned on a respective first lateral side and second lateral side of said torso, said side pads being spaced apart from each other and being distributed between said waist of said bodysuit and a respective one of said arms, each of said sets of leg pads being spaced apart from each other and being distributed between a knee of a respective leg and a crotch of said bodysuit, each of said foot pads being positioned on a sole of a respective foot of said bodysuit;
a plurality of triggers, each of said triggers being integrated into a respective one of said sound pads thereby facilitating each of said triggers to be actuated when the user touches or strikes said respective sound pad, each of said triggers being in communication with said speaker in said a respective one of said sound pads;
a conductor array, said conductor array being integrated into said bodysuit, said conductor array being in electrical communication with each of said triggers, said conductor array having an input;
a communication unit being insertable into said pocket, said communication unit being in communication with said speaker in each of said sound pads, said communication unit having data storage capabilities thereby facilitating said communication unit to store digital audio, said communication unit having wireless communication capabilities thereby facilitating said communication unit to download digital audio from a remote data source, said communication unit comprising:
a housing having an outer wall, said housing being insertable into said pocket;
a control circuit being integrated into said housing, said control circuit receiving an audio input, said control circuit including an electronic memory, said electronic memory storing said database comprising the digital audio, said electronic memory storing a database comprising a unique identity being assigned to each of said triggers, said control circuit communicating an audio signal to said speaker associated with a respective one of said triggers when said respective trigger is actuated thereby facilitating said speaker to emit the audible sound when the user touches or strikes said respective sound pad, said audio signal sent to said speaker associated with each of said triggers comprising an unique pitch and sound with respect to each other wherein said plurality of sound pads is configured to facilitate the user to produce music;
an output port being integrated into said outer wall of said housing, said output port being electrically coupled to said control circuit, said output port being placed in electrical communication with said input of said conductor array when said housing is inserted into said pocket thereby facilitating said control circuit to electrically communication with each of said triggers;
a receiver being integrated into said housing, said receiver being electrically coupled to said control circuit, said receiver being in wireless communication with a personal electronic device thereby facilitating said receiver to download data from said personal electronic device into said electronic memory; and
a power supply being integrated into said housing, said power supply being electrically coupled to said control circuit, said power supply comprising at least one battery.
